(19) United States
(12) Patent Application Publication
(10) Pub. No.: US 2025/0085562 A1
(43) Pub. Date: Mar. 13, 2025

(54) THREE-DIMENSIONAL REFLECTIVE DISPLAY DEVICE

(71) Applicant: E Ink Holdings Inc., HSINCHU (TW)

(72) Inventors: Shin-Bo LIN, HSINCHU (TW); Jen-Yuan CHI, HSINCHU (TW); Yu-Nan PAO, HSINCHU (TW); Chia-Ming HSIEH, HSINCHU (TW); Sheng-Wei CHEN, HSINCHU (TW); Chi-Mao HUNG, HSINCHU (TW)

(21) Appl. No.: 18/824,935

(22) Filed: Sep. 5, 2024

Related U.S. Application Data
(60) Provisional application No. 63/581,000, filed on Sep. 7, 2023.

(51) Int. Cl. G02B 30/27; F21V 8/00

(52) U.S. Cl. CPC G02B 30/27; G02B 6/004; G02B 6/0076; G02B 6/0088

(57) ABSTRACT

A three-dimensional reflective display device includes a reflective display panel, a lens array disposed on the reflective display panel, and a front light module disposed on the lens array. The reflective display panel includes pixel structures, and each pixel structure includes a left-eye pixel and a right-eye pixel. The lens array includes lenticular lenses extending in a first direction and arranged in a second direction perpendicular to the first direction. The lenticular lenses are respectively corresponding to the pixel structures. The front light module includes two front light components. The two front light components both include a light guide plate and a light source disposed on a light incident surface of the light guide plate, where the light incident surfaces face to each other in the second direction.

### RELATED APPLICATIONS

This application claims priority to U.S. Provisional Ser. No. 63/581,000, filed Sep. 7, 2023, which is herein incorporated by reference in its entirety.

### BACKGROUND

### Field of Invention

The present disclosure relates to a three-dimensional reflective display device. More particularly, the present disclosure relates to a three-dimensional reflective display device including two front light components both including a light guide plate and a light source.

### Description of Related Art

With the advancement of technology, three-dimensional (3D) display devices are developed to display three-dimensional images in response to the need to display more realistic images. Three-dimensional display devices can be divided into spectacle-type three-dimensional display devices that require spectacles for viewing and naked-eye type three-dimensional display devices that do not require spectacles for viewing, and stereoscopic imaging methods for naked-eye type three-dimensional display devices can mainly include parallax barrier methods and lenticular methods.

Therefore, the reflective display device can be combined with a lens array to form a three-dimensional reflective display device, and the three-dimensional reflective display device with a front light module can further provide sufficient illumination for use in situations where there is insufficient light. However, due to the limitation of the angle of light emitted from the front light module, dark areas are formed after the light passing through the lens array, resulting in the appearance of obvious bright and dark stripes on the image, which in turn leads to poor display quality.

### SUMMARY

At least one embodiment of the present disclosure provides a three-dimensional reflective display device that reduces the probability of dark areas being formed after light passes through the lens array, so as to avoid the appearance of obvious bright and dark stripes on the image, and thus improve the display quality.

The three-dimensional reflective display device according to at least one embodiment of the present disclosure includes a reflective display panel, a lens array and a front light module. The reflective display panel includes multiple pixel structures, where each of the pixel structures includes a left-eye pixel and a right-eye pixel. The lens array is disposed on the reflective display panel and includes multiple lenticular lenses extending in a first direction and arranged in a second direction perpendicular to the first direction, where the lenticular lenses are respectively corresponding to the pixel structures. The front light module is disposed on the lens array and includes a first front light component and a second front light component. The first front light component includes a first light guide plate and a first light source, where the first light guide plate has a first light incident surface, and the first light source is disposed at the first light incident surface. The second front light component is disposed between the lens array and the first front light component, and includes a second light guide plate and a second light source, where the second light guide plate has a second light incident surface, and the second light source is disposed at the second light incident surface. The first light incident surface faces the second light incident surface in the second direction.

The three-dimensional reflective display device according to at least another embodiment of the present disclosure includes a reflective display panel, a lens array and a front light module. The reflective display panel includes multiple pixel structures, where each of the pixel structures includes a left-eye pixel and a right-eye pixel. The lens array is disposed on the reflective display panel and includes multiple lenticular lenses extending in a first direction and arranged in a second direction perpendicular to the first direction, where the lenticular lenses are respectively corresponding to the pixel structures. The front light module is disposed on the lens array and includes a first front light component and a second front light component. The first front light component includes a first light guide plate and a first light source, where the first light guide plate has a first light incident surface, and the first light source is disposed at the first light incident surface. The second front light component is disposed between the lens array and the first front light component, and includes a second light guide plate and a second light source, where the second light guide plate has a second light incident surface, and the second light source is disposed at the second light incident surface. The first light guide plate has a first upper surface away from the second light guide plate, and the first upper surface includes multiple first microstructures. The second light guide plate has a second upper surface adjacent to the first light guide plate, and the second upper surface includes multiple second microstructures, where the first microstructures and the second microstructures extend in the first direction, and a cross-sectional shape of each of the first microstructures perpendicular to the first direction and a cross-sectional shape of each of the second microstructure perpendicular to the first direction are mirror symmetrical.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic cross-sectional view of a three-dimensional reflective display device according to at least one embodiment of the present disclosure.

FIG. 2A is a schematic cross-sectional view of a first microstructure according to at least one embodiment of the present disclosure.

FIG. 2B is a schematic cross-sectional view of a second microstructure according to at least one embodiment of the present disclosure.

FIG. 3 is a partial schematic cross-sectional view of a lens array according to at least one embodiment of the present disclosure.

FIG. 4A is a schematic diagram of the optical simulation result of the front light module of the comparative example after the light passes through the lens array.

FIG. 4B is a schematic diagram of the optical simulation result of the front light module of at least one embodiment of the present disclosure after the light passes through the lens array.

### DETAILED DESCRIPTION

The embodiments of the present disclosure are discussed in detail below. It will be appreciated, however, that the embodiments provide many applicable concepts which may be implemented in a wide variety of specific contexts. The discussed and disclosed embodiments are for illustrative purposes only and are not intended to limit the scope of patent applications in this case.

In the following description, in order to clearly present the technical features of the present disclosure, the dimensions of elements in the drawings will be enlarged in unequal proportions. Therefore, the description and explanation of the following embodiments are not limited to the sizes and shapes presented by the elements in the drawings, but should cover the sizes, shapes, and deviations of the two due to actual manufacturing processes and/or tolerances. For example, the flat surface shown in the drawings may have rough and/or non-linear characteristics, and the acute angle shown in the drawings may be round. Therefore, the elements presented in the drawings in this case are mainly for illustration, and are not intended to accurately depict the actual shape of the elements, nor are they intended to limit the scope of patent applications in this case.

Furthermore, the words “about”, “approximately” or “substantially” used in the present disclosure not only cover the clearly stated numerical values and numerical ranges, but also cover those that can be understood by a person with ordinary knowledge in the technical field to which the present disclosure belongs. The permissible deviation range can be determined by the error generated during measurement, and the error is caused, for example, by limitations of the measurement system or process conditions. For example, two objects (such as the plane or traces of a substrate) are “substantially parallel” or “substantially perpendicular,” where “substantially parallel” and “substantially perpendicular,” respectively, mean that parallelism and perpendicularity between the two objects can include non-parallelism and non-perpendicularity caused by permissible deviation ranges.

In addition, “about” may mean within one or more standard deviations of the above values, such as within +30%, +20%, +10%, or +5%. Such words as “about”, “approximately”, or “substantially” as appearing in the present disclosure may be used to select an acceptable range of deviation or standard deviation according to optical properties, etching properties, mechanical properties, or other properties, rather than applying all of the above optical properties, etching properties, mechanical properties, and other properties with a single standard deviation.

The spatial relative terms used in the present disclosure, such as “below,” “under,” “above,” “on,” and the like, are intended to facilitate the recitation of a relative relationship between one element or feature and another as depicted in the drawings. The true meaning of these spatial relative terms includes other orientations. For example, the relationship between one element and another may change from “below” and “under” to “above” and “on” when the drawing is turned 180 degrees up or down. In addition, spatially relative descriptions used in the present disclosure should be interpreted in the same manner.

It should be understood that while the present disclosure may use terms such as “first”, “second”, “third” to describe various elements or features, these elements or features should not be limited by these terms. These terms are primarily used to distinguish one element from another, or one feature from another. In addition, the term “or” as used in the present disclosure may include, as appropriate, any one or a combination of the listed items in association.

Moreover, the present disclosure may be implemented or applied in various other specific embodiments, and the details of the present disclosure may be combined, modified, and altered in various embodiments based on different viewpoints and applications, without departing from the idea of the present disclosure.

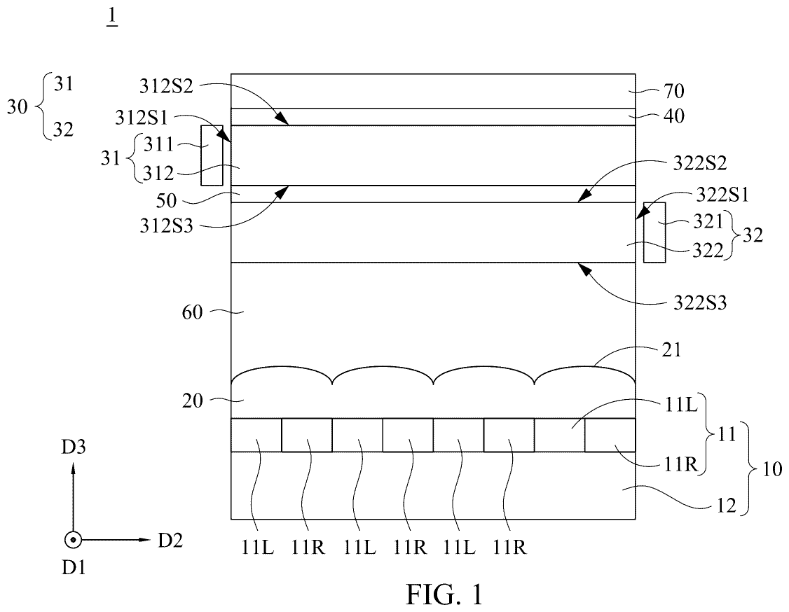

FIG. 1 is a schematic cross-sectional view of a three-dimensional reflective display device according to at least one embodiment of the present disclosure. The three-dimensional reflective display device 1 includes a reflective display panel 10, a lens array 20 and a front light module 30. The reflective display panel 10 includes multiple pixel structures 11, where each of the pixel structures 11 includes a left-eye pixel 11L and a right-eye pixel 11R.

The lens array 20 is disposed on the reflective display panel 10 and includes multiple lenticular lenses 21. The lenticular lenses 21 extend in a first direction D1 and are arranged in a second direction D2 substantially perpendicular to the first direction D1, and respectively correspond to the pixel structures 11.

The front light module 30 is disposed on the lens array 20, and includes a first front light component 31 and a second front light component 32. The first front light component 31 includes a first light source 311 and a first light guide plate 312. The first light guide plate 312 has a first light incident surface 312S1, where the first light source 311 is disposed at the first light incident surface 312S1. The second front light component 32 is disposed between the lens array 20 and the first front light component 31, and includes a second light source 321 and a second light guide plate 322. The second light guide plate 322 has a second light incident surface 322S1, where the second light source 321 is disposed at the second light incident surface 322S1. The first light incident surface 312S1 faces the second light incident surface 322S1 in the second direction D2.

Since the front light module includes two front light components (e.g., the first front light component 31 and the second front light component 32), and the light sources (e.g., the first light source 311 and the second light source 321) of the two front light components are disposed at opposite sides of the lenticular lens array (e.g., lens array 20). Therefore, the bright and dark zones formed by the light emitted from the two front light components after passing through the lenticular lens array are complementary to each other, which reduces the chance of dark areas being formed after the light passing through the lenticular lens array and prevents obvious bright and dark stripes from appearing on the image, thereby improving the display quality.

As shown in FIG. 1, the left-eye pixels 11L and the right-eye pixels 11R are arranged alternately in the second direction D2. The lenticular lenses 21 of the lens array 20 respectively overlap with the pixel structures 11 in the normal line of the reflective display panel 10 (that is, a third direction D3 substantially perpendicular to the first direction D1 and the second direction D2). In addition, the first light source 311, the lens array 20 and the second light source 321 are arranged sequentially in the second direction D2. That is, the first light source 311 and the second light source 321 are respectively disposed at opposite sides of the lens array 20 in the second direction D2.

In some embodiments, the left-eye pixels 11L and the right-eye pixels 11R of the pixel structures 11 display images that can be perceived by the viewer's left eye and right eye, respectively, and the images of the left-eye pixel 11L and the right-eye pixel 11R are respectively refracted by the lenticular lens 21 of the lens array 20 to have specific angles, such that the image of the left-eye pixel 11L can be focused on the viewer's left eye, and the image of the right-eye pixel 11R can be focused on the viewer's right eye to display a stereoscopic image.

Referring to FIG. 1, the three-dimensional reflective display device 1 further includes a first adhesive layer 40, a second adhesive layer 50, an intermediate layer 60 and a protective layer 70. The first adhesive layer 40 is disposed on the first front light component 31, and the refractive index of the first adhesive layer 40 is smaller than the refractive index of the first light guide plate 312. The second adhesive layer 50 is disposed between the first front light component 31 and the second front light component 32. The refractive index of the second adhesive layer 50 is smaller than the refractive index of the second light guide plate 322. The intermediate layer 60 is disposed between the lens array 20 and the second front light component 32. The intermediate layer 60 can be an air layer or an adhesive layer, where the refractive index of the adhesive layer is smaller than the refractive index of the second light guide plate 322.

In addition, the refractive index of the first adhesive layer 40 can also be smaller than the refractive index of the second light guide plate 322, and the refractive index of the second adhesive layer 50 and the refractive index of the intermediate layer 60 that is the adhesive layer can also be smaller than the refractive index of the first light guide plate 312. Since the refractive indexes of the aforementioned adhesive layers or the air layer are smaller than the refractive indexes of the light guide plates, it enables the front light module to have a better light output angle, which in turn enhances the light output efficiency.

The protective layer 70 is disposed on the first adhesive layer 40. The first adhesive layer 40 is used to adhere to the first light guide plate 312 and the protective layer 70. The second adhesive layer 50 is used to adhere to the second light guide plate 322 and the first light guide plate 312. If the intermediate layer 60 is an adhesive layer, it can be used to adhere to the lens array 20 and the second light guide plate 322. In other embodiments, if the intermediate layer 60 is an air layer, the three-dimensional reflective display device 1 may further include a sealant (not shown) disposed between the lens array 20 and the second front light component 32 and located at an edge of the lens array 20 for adhering the lens array 20 to the second light guide plate 322.

In detail, as shown in FIG. 1, the first light guide plate 312 has a first upper surface 312S2 away from the second light guide plate 322 and a first lower surface 312S3 opposite to the first upper surface 312S2, that is, the first lower surface 312S3 is closer to the second light guide plate 322 than the first upper surface 312S2. The second light guide plate 322 has a second upper surface 322S2 adjacent to the first light guide plate 312 and a second lower surface 322S3 opposite to the second upper surface 322S2, that is, the second lower surface 322S3 is further away from the first light guide plate 312 than the second upper surface 322S2.

The first adhesive layer 40 is disposed on the first upper surface 312S2 and adheres to the first upper surface 312S2. The second adhesive layer 50 is disposed between the first lower surface 312S3 and the second upper surface 322S2 and adheres to the first lower surface 312S3 and the second upper surface 322S2. If the intermediate layer 60 is an adhesive layer, it is disposed on the second lower surface 322S3 and adheres to the second lower surface 322S3.

In some embodiments, the materials of the first adhesive layer 40, the second adhesive layer 50 and the intermediate layer 60 which is the adhesive layer may include optical clear adhesive (OCA), optical clear resin (OCR) and/or other suitable materials. The refractive indexes of the first adhesive layer 40, the second adhesive layer 50 and the intermediate layer 60 which is an adhesive layer are smaller than 1.43. Since the refractive indexes of the aforementioned adhesive layers are smaller than 1.43, the front light module can have a better light output angle, which in turn enhances the light output efficiency.

In addition, the protective layer 70 can be a transparent substrate, such as a glass plate or a transparent plastic plate, and the material of the transparent plastic plate may include polyethylene terephthalate (PET), polymethylmethacrylate (PMMA), polycarbonate (PC), cyclic olefin copolymer (COC) or cyclic olefin polymer (COP).

In some embodiments, the reflective display panel 10 may be an electrophoretic display panel or an electrowetting display panel. As shown in FIG. 1, the reflective display panel 10 further includes a substrate 12. The pixel structures 11 are disposed on the substrate 12, where the substrate 12 has a reflective function. In addition, the first light source 311 and the second light source 321 may be light bars, and the light bar includes a circuit board and multiple light-emitting elements (not shown) disposed on the circuit board. In some embodiments, the light-emitting element may be a light-emitting diode (LED).

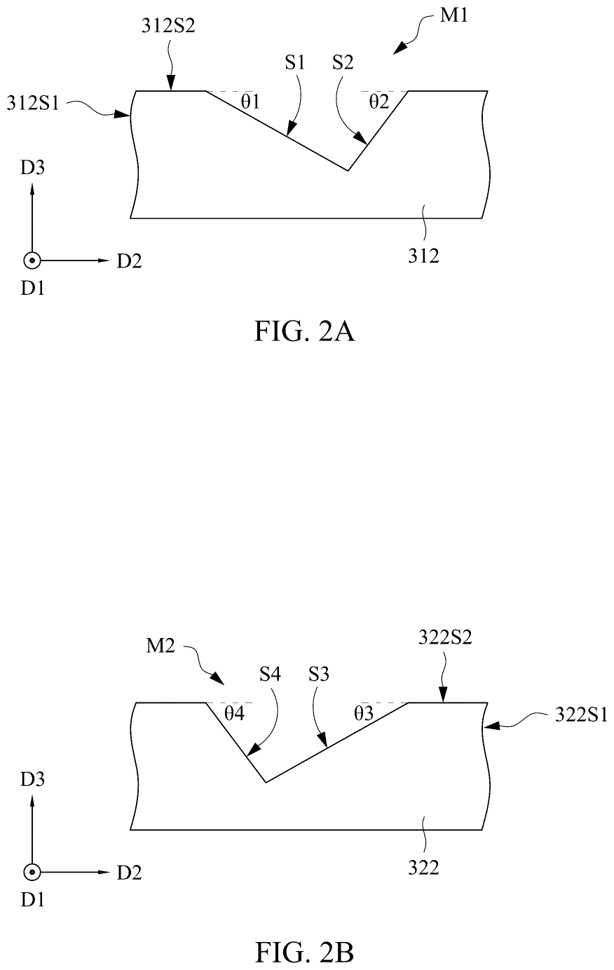

FIG. 2A is a schematic cross-sectional view of a first microstructure according to at least one embodiment of the present disclosure. FIG. 2B is a schematic cross-sectional view of a second microstructure according to at least one embodiment of the present disclosure. Referring to FIG. 2A and FIG. 2B, the first upper surface 312S2 of the first light guide plate 312 includes multiple first microstructures M1, and the second upper surface 322S2 of the second light guide plate 322 includes multiple second microstructures M2. It should be understood that although FIG. 2A and FIG. 2B illustrate merely one first microstructure M1 and one second microstructure M2, respectively, the first upper surface 312S2 and the second upper surface 322S2, which are not shown in the drawings, may also include other first microstructures M1 and other second microstructures M2, respectively.

As shown in FIG. 2A, the first microstructure M1 is a recessed structure, and the first microstructure M1 has a first light receiving surface S1 adjacent to the first light incident surface 312S1 and a first light back surface S2 away from the first light incident surface 312S1. The first light receiving surface S1 is inclined at a first light receiving angle θ1 with respect to the first light guide plate 312, and the first light receiving angle θ1 is 20 to 40 degrees. The first light back surface S2 is inclined at a first light back angle θ2 with respect to the first light guide plate 312, and the first light back angle θ2 is 60 to 89 degrees.

As shown in FIG. 2B, the second microstructure M2 is a recessed structure, and the second microstructure M2 has a second light receiving surface S3 adjacent to the second light incident surface 322S1 and a second light back surface S4 away from the second light incident surface 322S1. The second light receiving surface S3 is inclined at a second light receiving angle θ3 with respect to the second light guide plate 322, and the second light receiving angle θ3 is 20 to 40 degrees. The second light back surface S4 is inclined at a second light back angle θ4 with respect to the second light guide plate 322, and the second light back angle θ4 is 60 to 89 degrees.

The first microstructures M1 and the second microstructures M2 extend in the first direction D1 and are arranged in the second direction D2. In some embodiments, the first microstructures M1 are arranged at intervals in the second direction D2 and/or the second microstructures M2 are arranged at intervals in the second direction D2. That is, there is a spacing between any two adjacent first microstructures M1 and/or between any two adjacent second microstructures M2. In other embodiments, the first microstructures M1 are continuously arranged in the second direction D2, and/or the second microstructures M2 are continuously arranged in the second direction D2. That is, there is no spacing between any two adjacent first microstructures M1 and/or between any two adjacent second microstructures M2.

In addition, the first light receiving angle θ1 of the first microstructure M1 may be substantially equal to the second light receiving angle θ3 of the second microstructure M2, and the first light back angle θ2 of the first microstructure M1 may be substantially equal to the second light back angle θ4 of the second microstructure M2. That is, as shown in FIG. 2A and FIG. 2B, the cross-sectional shape of the first microstructure M1 substantially perpendicular to the first direction D1 and the cross-sectional shape of the second microstructure M2 substantially perpendicular to the first direction D1 are mirror symmetrical.

The abovementioned angle design of the first microstructures M1 and the second microstructures M2 can make the front light module have a better light output angle, thus enhancing the light output efficiency. Furthermore, since the cross-sectional shape of the first microstructure M1 substantially perpendicular to the first direction D1 and the cross-sectional shape of the second microstructure M2 substantially perpendicular to the first direction D1 are mirror symmetrical, it can enhance the possibility that the bright and dark zones formed by the light emitted from the first front light component 31 and the second front light component 32 after passing through the lens array 20 are complementary to each other, and further reduce the chance of dark areas being formed by the light after passing through the lens array 20, so as to effectively avoid the appearance of obvious bright and dark stripes on the image, and thus further improve the display quality.

However, the present disclosure is not limited to this. In other embodiments, the cross-sectional shape of the first microstructure M1 substantially perpendicular to the first direction D1 and the cross-sectional shape of the second microstructure M2 substantially perpendicular to the first direction D1 may not be mirror symmetrical. That is, the first light receiving angle θ1 of the first microstructure M1 is not equal to the second light receiving angle θ3 of the second microstructure M2, and the first light back angle θ2 of the first microstructure M1 is not equal to the second light back angle θ4 of the second microstructure M2.

It is worth noting that since the first microstructure M1 is a recessed structure, so the first adhesive layer 40 adhered to the first upper surface 312S2 is filled in the first microstructures M1, and the second microstructure M2 is a recessed structure, so the second adhesive layer 50 adhered to the second upper surface 322S2 is filled in the second microstructures M2. By filling in the microstructure of the light guide plate with the adhesive layer, where the refractive index of the adhesive layer is smaller than the refractive index of the light guide plate, it can effectively enable the front light module to have a better light output angle, and thus enhance the light output efficiency.

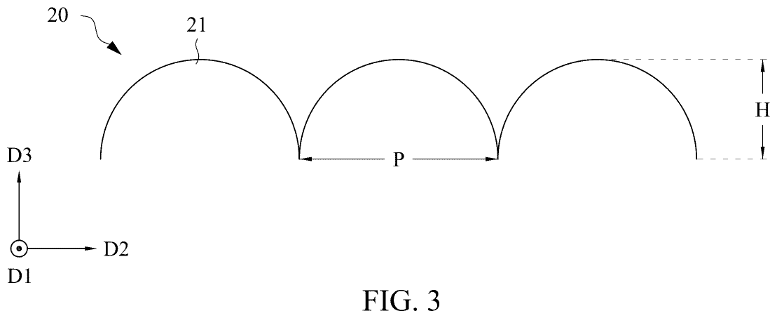

FIG. 3 is a partial schematic cross-sectional view of a lens array according to at least one embodiment of the present disclosure. Referring to FIG. 3, the lens array 20 has a height H in the normal line of the reflective display panel 10 (i.e., the third direction D3), and has a pitch P in the second direction D2, where the ratio of the height H to the pitch P is 0.08 to 0.3. By the design of the aforementioned ratio range, the three-dimensional reflective display device 1 can have a better optical stereoscopic effect.

As shown in FIG. 3, the pitch P is the width of the lenticular lens 21 in the second direction D2. In some embodiments, the width of the lenticular lens 21 in the second direction D2 (i.e., the pitch P) is substantially equal to the width of the pixel structure 11 in the second direction D2. That is, the ratio of the height H to the width of the pixel structure 11 in the second direction D2 is also 0.08 to 0.3.

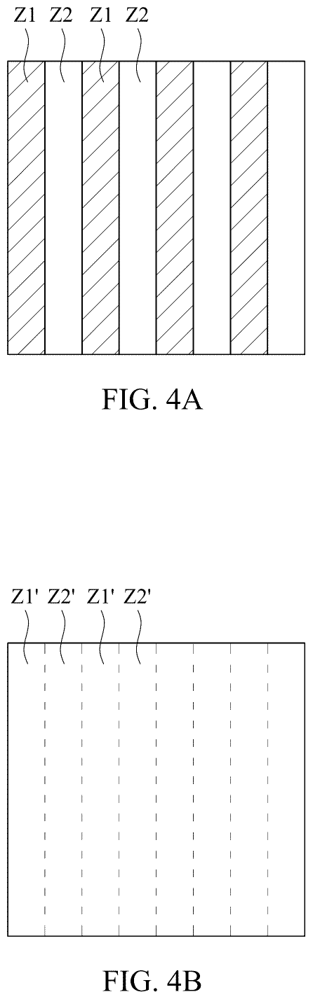

FIG. 4A is a schematic diagram of the optical simulation result of the front light module of the comparative example after the light passes through the lens array. FIG. 4B is a schematic diagram of the optical simulation result of the front light module of at least one embodiment of the present disclosure after the light passes through the lens array. Referring to FIG. 4A, which is the schematic diagram of the optical simulation result of the light emitted from a front light module including only one front light component (e.g., a first front light component 31 or a second front light component 32) after passing through a lens array (e.g., lens array 20), it can be seen in FIG. 4A that the zones Z1 and the zones Z2 are staggered arrangement of dark and bright patterns, respectively, i.e., the luminance of the zone Z1 is significantly lower than the luminance of the zone Z2.

Referring to FIG. 4B, which is the schematic diagram of the optical simulation result of the light emitted from the front light module 30 of the three-dimensional reflective display device 1 after passing through the lens array 20, it can be seen from FIG. 4B that the zones Z1′ and the zones Z2′ are not the staggered arrangement of dark and bright patterns like the zones Z1 and the zones Z2 of FIG. 4A, i.e., the luminance of the zone Z1′ is close to the luminance of the zone Z2′.

In summary, the present disclosure uses the front light module including two front light components, and the light sources of the two front light components are located at opposite sides of the lenticular lens array. Therefore, the bright and dark zones formed by the light emitted from the two front light components after passing through the lenticular lens array are complementary to each other, which reduces the chance of dark areas being formed by the light passing through the lenticular lens array and prevents obvious bright and dark stripes from appearing on the image, thereby improving the display quality.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A three-dimensional reflective display device, comprising:
a reflective display panel, comprising a plurality of pixel structures, wherein each of the pixel structures comprises a left-eye pixel and a right-eye pixel;
a lens array, disposed on the reflective display panel, and comprising a plurality of lenticular lenses extending in a first direction and arranged in a second direction perpendicular to the first direction, wherein the lenticular lenses are respectively corresponding to the pixel structures; and
a front light module, disposed on the lens array and comprising:
a first front light component, comprising a first light guide plate and a first light source, wherein the first light guide plate has a first light incident surface, and the first light source is disposed at the first light incident surface; and
a second front light component, disposed between the lens array and the first front light component, and comprising a second light guide plate and a second light source, wherein the second light guide plate has a second light incident surface, and the second light source is disposed at the second light incident surface, wherein the first light incident surface faces the second light incident surface in the second direction.

2. The three-dimensional reflective display device of claim 1, wherein the first light guide plate has a first upper surface away from the second light guide plate, and the first upper surface comprises a plurality of first microstructures, wherein the second light guide plate has a second upper surface adjacent to the first light guide plate, and the second upper surface comprises a plurality of second microstructures.

3. The three-dimensional reflective display device of claim 2, wherein the first microstructures and the second microstructures extend in the first direction, and a cross-sectional shape of each of the first microstructures perpendicular to the first direction and a cross-sectional shape of each of the second microstructure perpendicular to the first direction are mirror symmetrical.

4. The three-dimensional reflective display device of claim 2, wherein each of the first microstructures is a recessed structure, and each of the first microstructures has a first light receiving surface adjacent to the first light incident surface and a first light back surface away from the first light incident surface, wherein the first light receiving surface is inclined at a first light receiving angle with respect to the first light guide plate, and the first light receiving angle is 20 to 40 degrees, wherein the first light back surface is inclined at a first light back angle with respect to the first light guide plate, and the first light back angle is 60 to 89 degrees.

5. The three-dimensional reflective display device of claim 2, wherein each of the second microstructures is a recessed structure, and each of the second microstructures has a second light receiving surface adjacent to the second light incident surface and a second light back surface away from the second light incident surface, wherein the second light receiving surface is inclined at a second light receiving angle with respect to the second light guide plate, and the second light receiving angle is 20 to 40 degrees, wherein the second light back surface is inclined at a second light back angle with respect to the second light guide plate, and the second light back angle is 60 to 89 degrees.

6. The three-dimensional reflective display device of claim 2, wherein each of the first microstructures is a recessed structure, and each of the first microstructures has a first light receiving surface adjacent to the first light incident surface and a first light back surface away from the first light incident surface, wherein the first light receiving surface is inclined at a first light receiving angle with respect to the first light guide plate, and the first light back surface is inclined at a first light back angle with respect to the first light guide plate, wherein each of the second microstructures is a recessed structure, and each of the second microstructures has a second light receiving surface adjacent to the second light incident surface and a second light back surface away from the second light incident surface, wherein the second light receiving surface is inclined at a second light receiving angle with respect to the second light guide plate, and the second light back surface is inclined at a second light back angle with respect to the second light guide plate, wherein the first light receiving angle is equal to the second light receiving angle, and the first light back angle is equal to the second light back angle.

7. The three-dimensional reflective display device of claim 2, further comprising a first adhesive layer disposed on the first front light component, wherein a refractive index of the first adhesive layer is smaller than a refractive index of the first light guide plate.

8. The three-dimensional reflective display device of claim 7, further comprising a protective layer disposed on the first adhesive layer, wherein the first adhesive layer is disposed between the first light guide plate and the protective layer, and adheres to the first light guide plate and the protective layer.

9. The three-dimensional reflective display device of claim 7, wherein the refractive index of the first adhesive layer is smaller than 1.43.

10. The three-dimensional reflective display device of claim 7, wherein each of the first microstructures is a recessed structure, and the first adhesive layer is filled into the first microstructures.

11. The three-dimensional reflective display device of claim 2, further comprising a second adhesive layer disposed between the first front light component and the second front light component, wherein a refractive index of the second adhesive layer is smaller than a refractive index of the second light guide plate.

12. The three-dimensional reflective display device of claim 11, wherein the refractive index of the second adhesive layer is smaller than 1.43.

13. The three-dimensional reflective display device of claim 11, wherein each of the second microstructures is a recessed structure, and the second adhesive layer is filled into the second microstructures.

14. The three-dimensional reflective display device of claim 1, further comprising an intermediate layer disposed between the lens array and the second front light component, wherein the intermediate layer comprises an air layer or an adhesive layer, and a refractive index of the adhesive layer is smaller than a refractive index of the second light guide plate.

15. The three-dimensional reflective display device of claim 14, wherein the refractive index of the adhesive layer is smaller than 1.43.

16. The three-dimensional reflective display device of claim 1, wherein the lens array has a height at a normal line of the reflective display panel and a pitch in the second direction, and a ratio of the height to the pitch is 0.08 to 0.3.

17. A three-dimensional reflective display device, comprising:
a reflective display panel, comprising a plurality of pixel structures, wherein each of the pixel structures comprises a left-eye pixel and a right-eye pixel;
a lens array, disposed on the reflective display panel, and comprising a plurality of lenticular lenses extending in a first direction and arranged in a second direction perpendicular to the first direction, wherein the lenticular lenses are respectively corresponding to the pixel structures; and
a front light module, disposed on the lens array and comprising:
a first front light component, comprising a first light guide plate and a first light source, wherein the first light guide plate has a first light incident surface, and the first light source is disposed at the first light incident surface; and
a second front light component, disposed between the lens array and the first front light component, and comprising a second light guide plate and a second light source, wherein the second light guide plate has a second light incident surface, and the second light source is disposed at the second light incident surface,
wherein the first light guide plate has a first upper surface away from the second light guide plate, and the first upper surface comprises a plurality of first microstructures, wherein the second light guide plate has a second upper surface adjacent to the first light guide plate, and the second upper surface comprises a plurality of second microstructures, wherein the first microstructures and the second microstructures extend in the first direction, and a cross-sectional shape of each of the first microstructures perpendicular to the first direction and a cross-sectional shape of each of the second microstructure perpendicular to the first direction are mirror symmetrical.
